(19) United States
(12) Patent Application Publication
(10) Pub. No.: US 2022/0124702 A1
(43) Pub. Date: Apr. 21, 2022

(54) DYNAMIC REPETITION FOR A CONTROL CHANNEL

(71) Applicant: QUALCOMM Incorporated, San Diego, CA (US)

(72) Inventors: Mahmoud TAHERZADEH BOROUJENI, San Diego, CA (US); Tao LUO, San Diego, CA (US); Juan MONTOJO, San Diego, CA (US); Peter GAAL, San Diego, CA (US); Xiaoxia ZHANG, San Diego, CA (US)

(21) Appl. No.: 17/450,222

(22) Filed: Oct. 7, 2021

Related U.S. Application Data
(60) Provisional application No. 63/092,987, filed on Oct. 16, 2020.

(51) Int. Cl. H04W 72/04; H04L 1/08

(52) U.S. Cl. CPC H04W 72/0413; H04W 72/0446; H04L 1/08

(57) ABSTRACT

Various aspects of the present disclosure generally relate to wireless communication. In some aspects, a user equipment (UE) may receive, from a transmitter, information regarding repeating a communication associated with an uplink control channel. The UE may transmit the communication associated with the uplink control channel based at least in part on the information. Numerous other aspects are provided.

### CROSS-REFERENCE TO RELATED APPLICATION

This Patent Application claims priority to U.S. Provisional Patent Application No. 63/092,987, filed on Oct. 16, 2020, entitled “DYNAMIC REPETITION FOR A CONTROL CHANNEL,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for dynamic repetition for a control channel.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a transmitter, information regarding repeating a communication associated with an uplink control channel; and transmitting the communication associated with the uplink control channel based at least in part on the information.

In some aspects, a method of wireless communication performed by a transmitter includes transmitting, to a UE, information regarding repeating a communication associated with an uplink control channel; and receiving the communication associated with the uplink control channel based at least in part on the information.

In some aspects, a UE for wireless communication includes a memory; and one or more processors coupled to the memory, the one or more processors configured to: receive, from a transmitter, information regarding repeating a communication associated with an uplink control channel; and transmit the communication associated with the uplink control channel based at least in part on the information.

In some aspects, a transmitter for wireless communication includes a memory; and one or more processors coupled to the memory, the one or more processors configured to: transmit, to a UE, information regarding repeating a communication associated with an uplink control channel; and receive the communication associated with the uplink control channel based at least in part on the information.

In some aspects, a non-transitory computer-readable medium storing a set of instructions for wireless communication includes one or more instructions that, when executed by one or more processors of a UE, cause the UE to: receive, from a transmitter, information regarding repeating a communication associated with an uplink control channel; and transmit the communication associated with the uplink control channel based at least in part on the information.

In some aspects, a non-transitory computer-readable medium storing a set of instructions for wireless communication includes one or more instructions that, when executed by one or more processors of a transmitter, cause the transmitter to: transmit, to a UE, information regarding repeating a communication associated with an uplink control channel; and receive the communication associated with the uplink control channel based at least in part on the information.

In some aspects, an apparatus for wireless communication includes means for receiving, from a transmitter, information regarding repeating a communication associated with an uplink control channel; and means for transmitting the communication associated with the uplink control channel based at least in part on the information.

In some aspects, an apparatus for wireless communication includes means for transmitting, to a UE, information regarding repeating a communication associated with an uplink control channel; and means for receiving the communication associated with the uplink control channel based at least in part on the information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example associated with dynamic repetition for a control channel, in accordance with the present disclosure.

FIG. 4 is a diagram illustrating an example associated with dynamic repetition for a control channel, in accordance with the present disclosure.

FIGS. 5 and 6 are diagrams illustrating example processes associated with dynamic repetition for a control channel, in accordance with the present disclosure.

FIGS. 7 and 8 are diagrams illustrating example apparatuses associated with dynamic repetition for a control channel, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

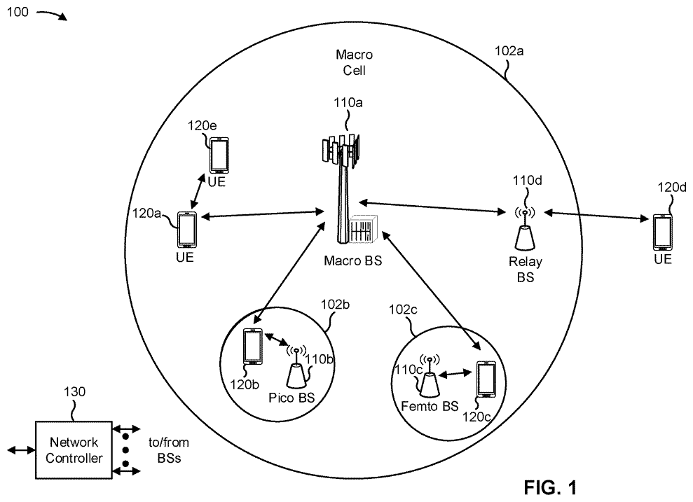

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment. UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

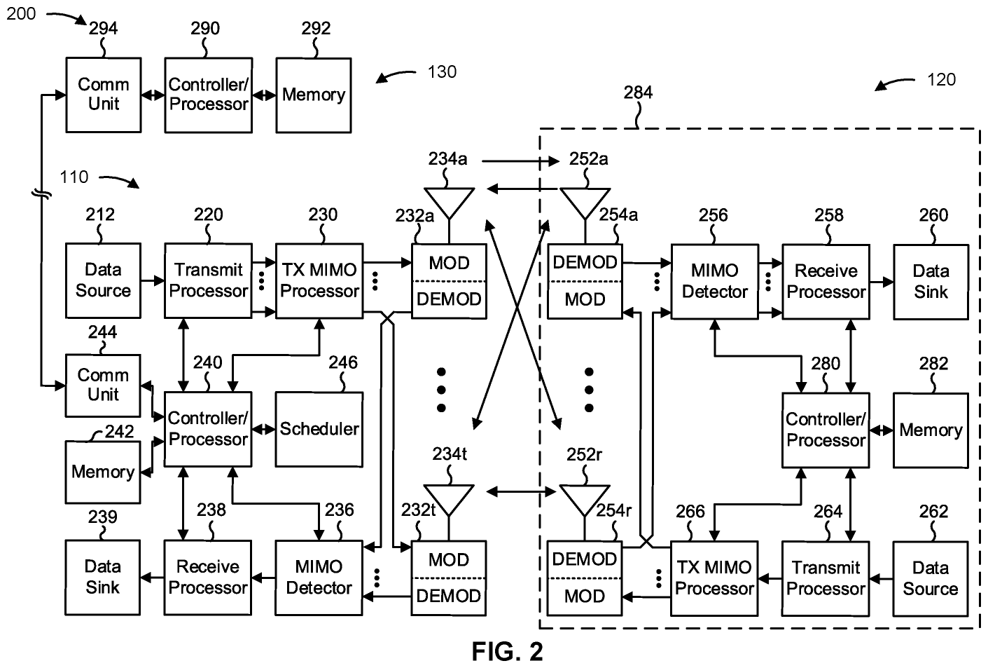

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

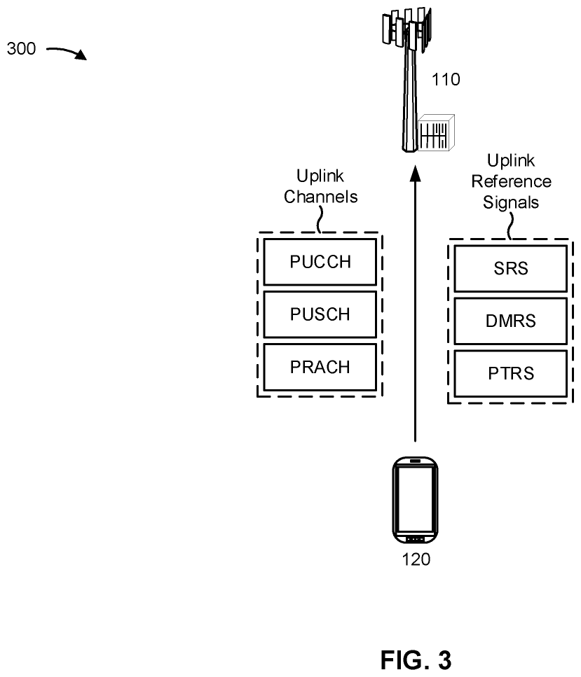

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 3-8).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 3-8).

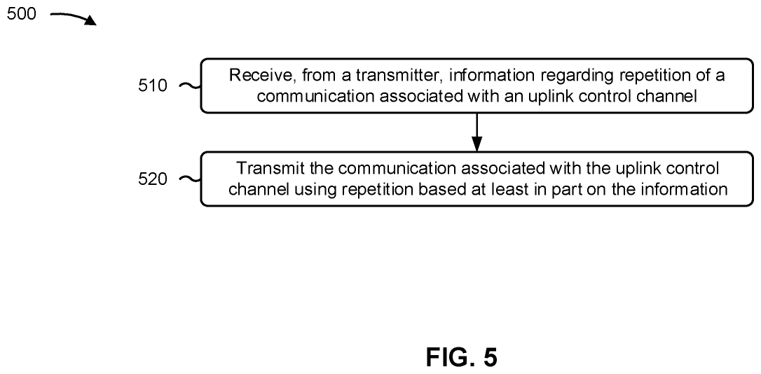

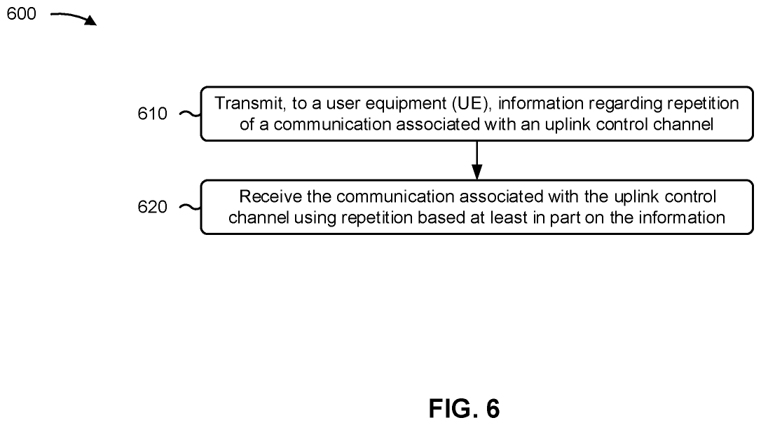

Controller/processor 240 of base station 110, controller/processor 280 of UE 120, and/or any other component(s) of FIG. 2 may perform one or more techniques associated with dynamic repetition for a control channel, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some aspects, executing instructions may include running the instructions, converting the instructions, compiling the instructions, and/or interpreting the instructions, among other examples.

In some aspects, a UE includes means for receiving, from a transmitter, information regarding repeating a communication associated with an uplink control channel; and/or means for transmitting the communication associated with the uplink control channel based at least in part on the information. The means for the UE to perform operations described herein may include, for example, antenna 252, demodulator 254, MIMO detector 256, receive processor 258, transmit processor 264, TX MIMO processor 266, modulator 254, controller/processor 280, and/or memory 282.

In some aspects, a transmitter (e.g., base station) includes means for transmitting, to a UE, information regarding repeating a communication associated with an uplink control channel; and/or means for receiving the communication associated with the uplink control channel based at least in part on the information. The means for the transmitter to perform operations described herein may include, for example, transmit processor 220, TX MIMO processor 230, modulator 232, antenna 234, demodulator 232, MIMO detector 236, receive processor 238, controller/processor 240, memory 242, and/or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

A UE may conduct data communication with a BS in a wireless network such as an LTE network or a 5G/NR network. The data communication may include downlink communications from the BS to the UE and may include uplink communications from the UE to the BS. The downlink communications may include downlink control information (DCI) and downlink payload data, and the uplink communications may include uplink control information (UCI) and uplink payload data.

Adequate reception of the DCI by the UE and adequate reception of the UCI by the BS may be crucial for the data communication. This is because the UE may utilize information included in the DCI to perform communication operations related to the data communication. For instance, the DCI may include information such as, for example, resource block assignment and/or modulation and coding scheme, which the UE may utilize to receive and decode the downlink payload data. Similarly, the BS may utilize information included in the UCI to perform communication operations related to the data communication. For instance, the UCI may include information such as, for example, a CQI, scheduling requests (SR), and/or hybrid automatic repeat request (HARQ) messages, which the BS may utilize to receive and decode the uplink payload data.

An uplink quality, associated with adequate reception of the UCI by the BS, may depend on a coverage quality associated with a coverage provided by the BS to the UE. For instance, the uplink quality may improve with improvement in the coverage quality and may deteriorate with deterioration in the coverage quality. The coverage quality may deteriorate due to, for example, a threshold amount of interference (e.g., inter-symbol interference and/or blockage due to physical obstructions) and/or a threshold amount of path loss based on a threshold distance between the BS and the UE, thereby resulting in a reduced signal-to-interference-plus-noise ratio (SINR) at the BS. When the coverage quality deteriorates, the uplink quality may deteriorate such that the BS may not adequately receive the UCI and, therefore, may not be able to receive and decode the uplink payload data. As a result, the data communication between the BS and the UE may experience an interruption or a stoppage. Interruptions of data communications may be particularly problematic for short channels, such as a physical uplink control channel (PUCCH) using a short PUCCH format (e.g., PUCCH Format 0 or 2, which may be specified in a wireless communication specification).

Various aspects of techniques and apparatuses described herein may enable dynamic repetition for a control channel. In some aspects, the techniques and apparatuses described herein may enable a UE to repeat transmission of UCI to a BS over an uplink control channel. Such repetition of transmission of the UCI may enable an increase in transmission energy associated with transmission of the UCI at the UE, thereby resulting in an increase in reception energy (e.g., SINR) associated with the reception of the UCI at the BS. Some techniques and apparatuses described herein may be used for repetition of UCI via a PUCCH associated with a short PUCCH format (e.g., PUCCH Format 0 or 2). In this way, adequate reception of the UCI may be enabled, particularly for UCI transmitted via a short PUCCH. Adequate reception of the UCI may enable the BS to reliably receive and decode uplink payload data. Accordingly, data communication between the BS and the UE may continue uninterrupted.

In some aspects, the UE may receive, from a transmitter (e.g., a BS), information regarding repeating a communication associated with an uplink control channel, and may transmit the communication associated with the uplink control channel based at least in part on the information. In some aspects, the uplink control channel may be a PUCCH, and the UE may transmit a short PUCCH based at least in part on the information. The short PUCCH may carry the UCI. Although the various aspects of techniques and apparatuses have been described using the PUCCH as an example, the techniques and apparatuses are may analogously apply to a physical sidelink control channel (PSCCH) as well.

FIG. 3 is a diagram illustrating an example 300 associated with dynamic repetition for a control channel, in accordance with the present disclosure. In some aspects, the control channel may include an uplink channel utilized to communicate a reference signal that carries information from a UE 120 to a BS 110. As shown, the uplink channel may include a PUCCH that carries UCI, a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

The PUCCH may include multiple formats including, for example, (i) a long PUCCH configured to be transmitted utilizing four or more orthogonal frequency division multiplexing (OFDM) symbols and (ii) a short PUCCH configured to be transmitted utilizing two or fewer OFDM symbols. In some aspects, the short PUCCH may carry two or fewer UCI bits. In some aspects, the short PUCCH may carry more than two UCI bits.

When the UE 120 transmits the short PUCCH carrying two or fewer UCI bits utilizing a single OFDM symbol (e.g., a one-symbol short PUCCH), the UE 120 may realize a low peak-to-average power ratio (PAPR) thereby enabling transmission of the short PUCCH at a higher amplification level which improves reception of the short PUCCH. In some aspects, the UE 120 may utilize the one-symbol short PUCCH for simultaneous transmission of a 2-bit ACK message and an SR. In some aspects, the UE 120 may utilize consecutive mapping of, for example, 12 tones of a computer-generated sequence within a physical resource block (PRB) to transmit the one-symbol short PUCCH. In some aspects, the PRB may support a plurality of base sequences (e.g., 30 base sequences), with a plurality of cyclic shifts (e.g., 12 cyclic shifts) available for each base sequence.

When the UE 120 transmits the short PUCCH carrying two or fewer UCI bits utilizing two OFDM symbols (e.g., a two-symbol short PUCCH), the UE 120 may utilize two one-symbol short PUCCHs and may enable sequence hopping between the two one-symbol short PUCCHs. Frequency hopping (e.g., switching of utilized frequencies) between the two one-symbol short PUCCHs may also be enabled when the two one-symbol short PUCCHs are transmitted utilizing adjacent PRBs. In some aspects, the frequency hopping may occur within an active bandwidth part that is actively utilized by the UE for data communication between the UE 120 and the BS 110.

When the UE 120 transmits the short PUCCH carrying more than two UCI bits utilizing either the one-symbol short PUCCH or the two-symbol short PUCCH, the UE 120 may multiplex reference signal (RS) bits with the UCI bits. In some aspects, the RS bits and the UCI bits may be mapped on different subcarriers and may support coherent demodulation. In some aspects, encoded UCI bits may be scrambled utilizing pseudo-random number sequences initialize based on a scrambling identifier for the PUSCH. In some aspects, a number of PRBs that can be utilized to transmit the short PUCCH may be configurable. In some aspects, the number of PRBs may be determined based at least in part on (i) a number of UCI bits, (ii) a maximum code-rate, (iii) a size of a UCI payload, (iv) a dynamic indication received via DCI, and/or (v) a total number of configured PRBs available to the UE 120.

In some aspects, when the UE 120 transmits the short PUCCH carrying more than two UCI bits utilizing the two-symbol short PUCCH, the UCI bits may be mapped across two OFDM symbols. Frequency hopping (e.g., switching of utilized frequencies) between the two OFDM symbols may be enabled, and may occur within the active bandwidth part that is actively utilized by the UE 120 for the data communication between the UE 120 and the BS 110. In some aspects, based at least in part on receiving network configuration information, the UE 120 may simultaneously transmit ACK messages and channel status information (CSI) messages. The ACK and CSI messages may be transmitted with or without a scheduling request.

An uplink reference signal may include a sounding reference signal (SRS), a DMRS, or a phase tracking reference signal (PTRS), among other examples. An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

A DMRS may carry information used to estimate a radio channel for demodulation of an associated physical channel (e.g., physical downlink control channel (PDCCH), physical downlink shared channel (PDSCH), physical broadcast channel (PBCH), PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

In some aspects, a plurality of DMRSs (e.g., four DMRSs) may be evenly distributed among subcarriers within a PRB. A similar DMRS density and/or pattern may be utilized to transmit the two-symbol short PUCCH as utilized to transmit the one-symbol short PUCCH. A sequence utilized to transmit a DMRS over PUCCH may be similar to a sequence utilized to transmit a DMRS over a PUSCH, and may be obtained utilizing a pseudo-random sequence generator.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A positioning reference signal (PRS) may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

As indicated above, FIG. 3 is provided as an example. Other examples may differ from what is described with regard to FIG. 3.

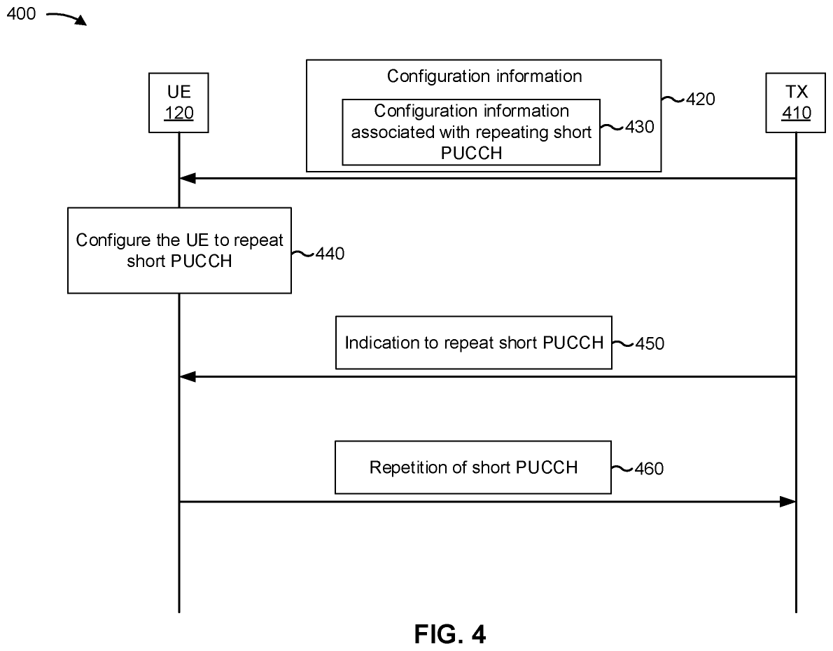

FIG. 4 is a diagram illustrating an example 400 associated with dynamic repetition for a control channel, in accordance with the present disclosure. FIG. 4 shows a UE 120 and a transmitter (TX) 410 conducting data communication in, for example, an LTE network or a 5G/NR network. The TX 410 may include a relay device or a network node such as, for example, a relay BS, a relay UE, and/or an integrated access and backhaul (IAB) node. The data communication may include downlink communications from the TX 410 to the UE 120 and may include uplink communications from the UE 120 to the TX 410. The downlink communications may include DCI and downlink payload data, and the uplink communications may include UCI and uplink payload data.

As shown by reference number 420, the TX 410 may transmit, and the UE 120 may receive, configuration information. In some aspects, the UE 120 may receive the configuration information from a device other than TX 410 (e.g., from another base station). In some aspects, the UE 120 may receive the configuration information via, for example, a control channel (e.g., a PDCCH) established between the UE 120 and the TX 410. The configuration information may be communicated via radio resource control (RRC) signaling, medium access control (MAC) signaling, DCI, or a combination thereof (e.g., RRC configuration of a set of values for a parameter and DCI indication of a selected value of the parameter). In some aspects, the DCI may include information such as, for example, a resource block assignment and/or a modulation and coding scheme, which the UE may utilize to receive and decode downlink payload data such as a PDSCH.

In some aspects, the configuration information may include an indication of, for example, one or more configuration parameters for the UE 120 to use to configure the UE 120 for the data communication. For instance, as shown by reference number 430, the configuration information may include information regarding repeating a communication associated with an uplink control channel, such as configuration information associated with the UE 120 repeating a communication associated with an uplink control channel. The uplink control channel may be the PUCCH and the communication may include a short PUCCH carrying UCI. In some aspects, it may be helpful to repeat a transmission of the short PUCCH because the short PUCCH may be susceptible to, for example, interference. While operating in some networks or frequency ranges (e.g., millimeter wave), the TX 410 may prefer to receive the UCI via the short PUCCH, as opposed to receiving the UCI via a long PUCCH, because processing the short PUCCH may consume fewer resources of the TX 410 with respect to a quantity of resources to process the long PUCCH. In this way, the TX 410 may be enabled to efficiently utilize its resources while serving a plurality of UEs.

As shown by reference number 440, the UE 120 may configure the UE 120 to repeat the short PUCCH. In some aspects, based at least in part on the configuration information, the UE 120 may configure the UE 120 to repeat a transmission of the short PUCCH. In some aspects, the UE 120 may configure the UE 120 to repeat transmission of the short PUCCH by transmitting multiple copies of the short PUCCH.

In some aspects, the UE 120 may repeat transmission of the short PUCCH based at least in part on receiving an indication from the TX 410 to repeat transmission of the short PUCCH. The indication may be a dynamic (e.g., real-time) indication, and may be received via a DCI message or via a MAC message. Additionally, or alternatively, the indication may be a semi-static indication, and may be received via a network configuration message such as, for example, an RRC configuration message.

In some aspects, the UE 120 may receive the indication periodically and/or aperiodically. For instance, the UE 120 may receive the semi-static indication periodically at preconfigured intervals of time and/or may receive the dynamic indication aperiodically. In some aspects, the UE 120 may receive the indication via a UE-specific message specifically transmitted to the UE 120, for example, based at least in part on DCI directed to the UE 120. In some aspects, the UE 120 may receive the indication via a group-common message transmitted to a group of UEs including the UE 120.

In some aspects, the UE 120 may configure the UE 120 to repeat transmission of the short PUCCH based at least in part on a specification from TX 410 (e.g., a specification of the number of repetitions). Such specification of the number of repetitions may be explicit. For instance, the indication may explicitly state the number of times for the UE 120 to repeat transmission of the short PUCCH. In another example, the indication may explicitly indicate that the UE 120 is to select one from a plurality of preconfigured repetition modes, each repetition mode being associated with a respective number of times for the UE 120 to repeat transmission of the short PUCCH. In some aspects, the configuration information may include information associated with the preconfigured repetition modes.

Additionally, or alternatively, the TX 410 may implicitly specify the number of times for the UE 120 to repeat transmission of the short PUCCH via, for example, other signaling. In an example, during the data communication, the TX 410 may transmit a coverage quality message to inform the UE 120 of a quality of a coverage provided by the TX 410 to the UE 120. Based at least in part on information in the coverage quality message, the UE 120 may, for example, start repeating transmission of the short PUCCH, regulate (e.g., increase or decrease) a number of times that the UE 120 repeats transmission of the short PUCCH, or abandon repeating transmission of the short PUCCH.

When the information in the coverage quality message indicates that the quality of the coverage has deteriorated, the UE 120 may start repeating transmission of the short PUCCH and/or increase a number of times that the UE 120 repeats transmission of the short PUCCH. When the information in the coverage quality message indicates that the quality of the coverage has improved, the UE 120 may decrease a number of times that the UE 120 repeats transmission of the short PUCCH. When the information in the coverage quality message indicates that the quality of the coverage has improved by a threshold amount or that the quality of the coverage satisfies a threshold quality level (e.g., the quality of the coverage is higher than the threshold quality level), the UE 120 may abandon repeating transmission of the short PUCCH.

In another example, during the data communication, the TX 410 may transmit a beam-switching message (e.g., a beam-switching MAC control element (MAC-CE)) indicating that the UE 120 is to switch a beam utilized for the data communication. Based at least in part on receiving the beam-switching message, the UE 120 may transmit an acknowledgment message to the TX 410. Based at least in part on receiving the beam-switching message and/or transmitting the acknowledgment message, the UE 120 may, for example, start repeating transmission of the short PUCCH, regulate (e.g., increase or decrease) a number of times that the UE 120 repeats transmission of the short PUCCH, or abandon repeating transmission of the short PUCCH.

For instance, when the beam-switching message indicates that the UE 120 is to switch to a beam having a coverage quality that fails to satisfy a threshold quality level (e.g., the quality of the coverage is lower than the threshold quality level), the UE 120 may start repeating transmission of the short PUCCH and/or increase a number of times that the UE 120 repeats transmission of the short PUCCH. When the beam-switching message indicates that the UE 120 is to switch to a beam having a coverage quality that satisfies the threshold quality level (e.g., the quality of coverage is higher than the threshold quality level), the UE 120 may decrease a number of times that the UE 120 repeats transmission of the short PUCCH. When the beam-switching message indicates that the UE 120 is to switch to a beam having a coverage quality that satisfies the threshold quality level by a threshold amount, the UE 120 may abandon repeating transmission of the short PUCCH.

In some aspects, the indication may include information that the TX 410 is to perform a sweep of reception beams associated with the PUCCH to recover the repeated transmissions (e.g., multiple copies) of the short PUCCH. Based at least in part on such information, the UE 120 may repeat transmission of the short PUCCH in a way suitable to facilitate a combined reception of the short PUCCH by the TX 410 based at least in part on the sweep of the reception beams. In some aspects, the combined reception of the short PUCCH by the TX 410 may enable an increase in an SINR at the TX 410, thereby enabling adequate reception of the short PUCCH by the TX 410. In some aspects, the indication may include information that the UE 120 is to perform a sweep of transmission beams associated with the PUCCH. Based at least in part on such information, the UE 120 may repeat transmission of the short PUCCH in a way suitable to facilitate adequate reception of the short PUCCH by the TX 410. For instance, the UE 120 may repeat transmission of the short PUCCH over the transmission beams in preconfigured directions in bursts at regular intervals.

As discussed with respect to FIG. 3, the UE 120 may transmit the short PUCCH utilizing the one-symbol short PUCCH and/or the two-symbol short PUCCH. In some aspects, the UE 120 may transmit the one-symbol short PUCCH and/or the two-symbol short PUCCH via one or more slots. A slot may include, for example, 14 symbols (e.g., symbol 0, symbol 1, symbol 2, symbol 3, . . . , symbol 13). In an example, the UE 120 may transmit a one-symbol short PUCCH during symbol 7 of a first slot and repeat transmission of the one-symbol short PUCCH during symbol 8 of the first slot. Further, the UE 120 may repeat transmission of the one-symbol short PUCCH during symbol 11 and/or symbol 12 of the first slot (e.g., back-to-back repetition). Alternatively, the UE 120 may repeat transmission of the one-symbol short PUCCH during symbol 10 and/or symbol 13 of the first slot. As such, the UE 120 may transmit the one-symbol short PUCCH, for example, four times (e.g., four copies of the one-symbol short PUCCH) in the first slot. Additionally, or alternatively, the UE 120 may repeat transmission of the one-symbol short PUCCH during symbol 7 and/or symbol 8 of a second slot. In some aspects, the first slot and the second slot may be successive slots transmitted by the UE 120 to the TX 410.

In another example, the UE 120 may transmit a two-symbol short PUCCH during symbol 7 and symbol 8 of a first slot and repeat transmission of the two-symbol short PUCCH during symbol 11 and symbol 12 of the first slot. In this example, the UE 120 may transmit the two-symbol short PUCCH two times (e.g., two copies of the two-symbol short PUCCH) in the first slot. Additionally, or alternatively, the UE 120 may repeat transmission of the two-symbol short PUCCH during symbol 7 and symbol 8 of a second slot. In some aspects, the UE 120 may repeat transmission of the two-symbol short PUCCH during symbol 13 of the first slot and symbol 0 of the second slot. In other words, the two-symbol short PUCCH may bridge two slots. In some aspects, the first slot and the second slot may be successive slots transmitted by the UE 120 to the TX 410.

The above number and arrangement of the short PUCCHs (e.g., one-symbol short PUCCH and/or two-symbol short PUCCH) are provided as examples. In practice, the UE 120 may transmit additional short PUCCHs, fewer short PUCCHs, or a combination of one or more of the one-symbol short PUCCHs and one or more of the two-symbol short PUCCH via the one or more slots. Further, the short PUCCHs may be arranged among symbols of a slot differently than as discussed above.

As shown by reference number 450, the UE 120 may receive the indication to repeat the short PUCCH from the TX 410. In some aspects, the UE 120 may receive the indication (e.g., dynamic indication and/or semi-static indication), as discussed above. Based at least in part on receiving the indication to repeat the short PUCCH, as shown by reference number 460, the UE 120 may repeat transmission of the short PUCCH, as discussed above. The UE 120 may utilize included reception circuitry to receive the indication and may utilize included transmission circuitry to repeat transmission of the short PUCCH. The transmission circuitry may include, for example, one or more components (e.g., transmit processor 264, TX MIMO processor 266, modulator 254, and/or antennas 252) discussed with respect to FIG. 2, and the reception circuitry may include, for example, one or more components (e.g., receive processor 258, MIMO detector 256, demodulator 254, and/or antennas 252).

In this way, by enabling repetition of the short PUCCH that carries UCI, the techniques and apparatuses described herein may provide an increase in transmission energy associated with transmission of the UCI at the UE 120, thereby resulting in an increase in reception energy (e.g., SINR) associated with the reception of the UCI at the TX 410. As a result, the TX 410 may adequately receive the UCI, and, therefore, receive and decode uplink payload data without interruption. Accordingly, the data communication between the TX 410 and the UE 120 may be improved.

As indicated above, FIG. 4 is provided as an example. Other examples may differ from what is described with regard to FIG. 4.

FIG. 5 is a diagram illustrating an example process 500 associated with dynamic repetition for a control channel and performed, for example, by a UE (e.g., UE 120), in accordance with the present disclosure. Example process 500 is an example where the UE performs operations associated with dynamic repetition for a control channel.

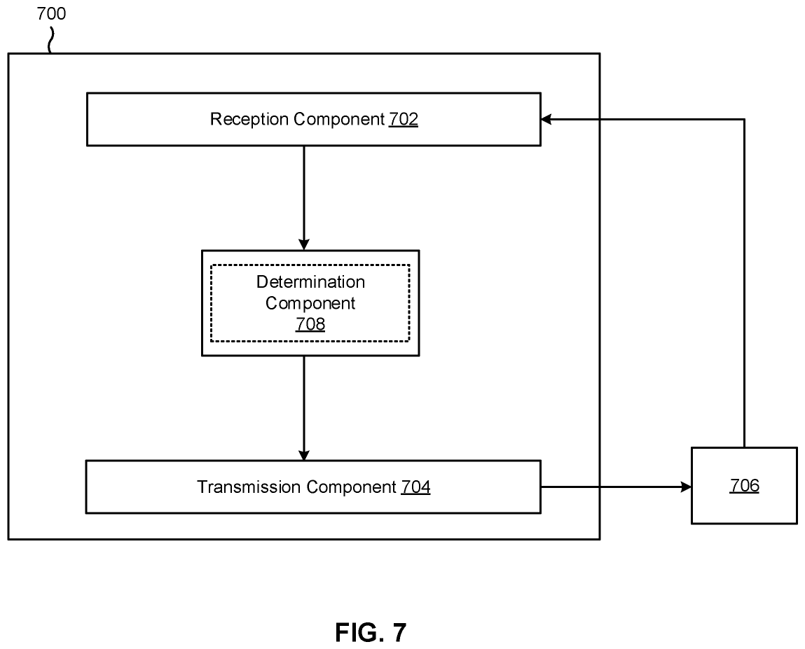

As shown in FIG. 5, in some aspects, process 500 may include receiving, from a transmitter, information regarding repeating a communication associated with an uplink control channel (block 510). For example, the UE (e.g., using reception component 702, depicted in FIG. 7) may receive, from a transmitter, information regarding repeating a communication associated with an uplink control channel, as described above in connection with FIGS. 3 and 4.

In some aspects, the information indicates performance of a sweep of a reception beam associated with the communication. In some aspects, the information indicates that the transmitter is to perform a sweep of a reception beam associated with the communication. In some aspects, the information indicates performance of a sweep of a transmission beam associated with the communication. In some aspects, the information indicates that the UE is to perform a sweep of a transmission beam associated with the communication. In some aspects, the communication includes uplink control information, and the information indicates a number of times associated with repeating the communication. In some aspects, the information is received via a network configuration message. In some aspects, the information is received via a DCI message or via a MAC message. In some aspects, the information is received via a UE-specific message. In some aspects, the information is received via a group-common message. In some aspects, the uplink control channel is a PUCCH. In some aspects, the information includes receiving the information aperiodically. In some aspects, the information explicitly indicates a number of times associated with repeating the communication. In some aspects, the information implicitly indicates a number of times associated with repeating the communication.

As further shown in FIG. 5, in some aspects, process 500 may include transmitting the communication associated with the uplink control channel based at least in part on the information (block 520). For example, the UE (e.g., using transmission component 704, depicted in FIG. 7) may transmit the communication associated with the uplink control channel based at least in part on the information, as described above in connection with FIGS. 3 and 4.

In some aspects, the uplink control channel is a PUCCH, and transmitting the communication includes transmitting a short PUCCH. In some aspects, transmitting the communication includes transmitting uplink control information. In some aspects, transmitting the communication includes transmitting the communication over multiple slots. In some aspects, transmitting the communication includes transmitting the communication over successive slots.

Process 500 may include additional aspects, such as any single aspect or any combination of aspects described above, below, and/or in connection with one or more other processes described elsewhere herein.

In a first aspect, process 500 includes the uplink control channel is a PUCCH, and transmitting the communication includes transmitting a short PUCCH.

In a second aspect, alone or in combination with the first aspect, transmitting the communication includes transmitting uplink control information.

In a third aspect, alone or in combination with one or more of the first and second aspects, the information indicates performance of a sweep of a reception beam associated with the communication.

In a fourth aspect, alone or in combination with one or more of the first through third aspects, the information indicates that the transmitter is to perform a sweep of a reception beam associated with the communication.

In a fifth aspect, alone or in combination with one or more of the first through fourth aspects, the information indicates performance of a sweep of a transmission beam associated with the communication.

In a sixth aspect, alone or in combination with one or more of the first through fifth aspects, the information indicates that the UE is to perform a sweep of a transmission beam associated with the communication.

In a seventh aspect, alone or in combination with one or more of the first through sixth aspects, process 500 includes the communication includes uplink control information, and the information indicates a number of times associated with repeating the communication.

In an eighth aspect, alone or in combination with one or more of the first through seventh aspects, the information is received via a network configuration message.

In a ninth aspect, alone or in combination with one or more of the first through eighth aspects, the information is received via a DCI message or via a MAC message.

In a tenth aspect, alone or in combination with one or more of the first through ninth aspects, the information is received via a UE-specific message.

In an eleventh aspect, alone or in combination with one or more of the first through tenth aspects, the information is received via a group-common message.

In a twelfth aspect, alone or in combination with one or more of the first through eleventh aspects, the uplink control channel is a PUCCH.

In a thirteenth aspect, alone or in combination with one or more of the first through twelfth aspects, receiving the information includes receiving the information aperiodically.

In a fourteenth aspect, alone or in combination with one or more of the first through thirteenth aspects, transmitting the communication includes transmitting the communication over multiple slots.

In a fifteenth aspect, alone or in combination with one or more of the first through fourteenth aspects, transmitting the communication includes transmitting the communication utilizing successive slots.

In a sixteenth aspect, alone or in combination with one or more of the first through fifteenth aspects, the information explicitly indicates a number of times associated with repeating the communication.

In a seventeenth aspect, alone or in combination with one or more of the first through sixteenth aspects, the information implicitly indicates a number of times associated with repeating the communication.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 associated with dynamic repetition for a control channel and performed, for example, by a transmitter (e.g., TX 410), in accordance with the present disclosure. Example process 600 is an example where the transmitter performs operations associated with dynamic repetition for a control channel.

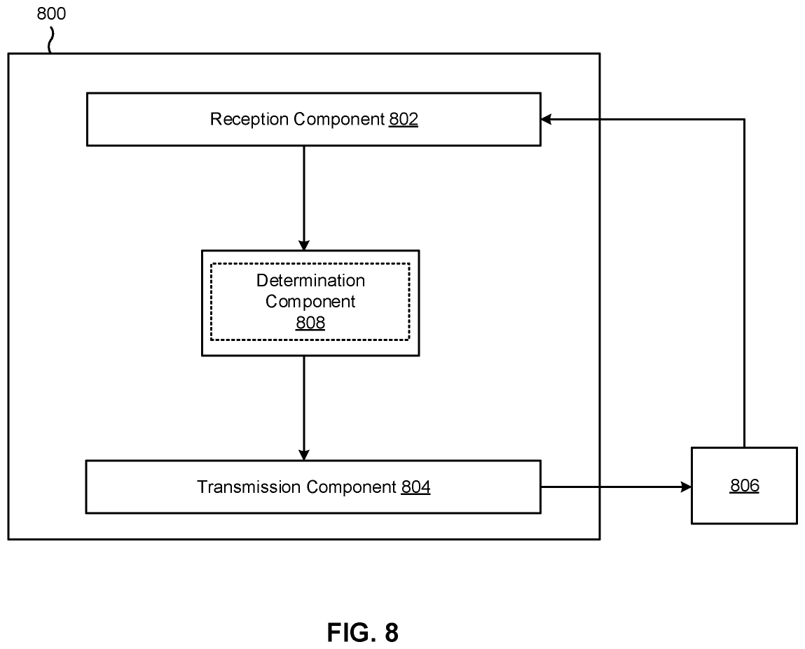

As shown in FIG. 6, in some aspects, process 600 may include transmitting, to a UE, information regarding repeating a communication associated with an uplink control channel (block 610). For example, the transmitter (e.g., using transmission component 804, depicted in FIG. 8) may transmit, to a UE, information regarding repeating a communication associated with an uplink control channel, as described above in connection with FIGS. 3 and 4.

In some aspects, the information indicates performance of a sweep of a reception beam associated with the communication. In some aspects, the information indicates that the transmitter is to perform a sweep of a reception beam associated with the communication. In some aspects, the information indicates performance of a sweep of a transmission beam associated with the communication. In some aspects, the information indicates that the UE is to perform a sweep of a transmission beam associated with the communication. In some aspects, the communication includes uplink control information, and the information indicates a number of times associated with repeating the communication. In some aspects, the information is transmitted via a network configuration message. In some aspects, the information is transmitted via a DCI message or via a MAC message. In some aspects, the information is transmitted via a UE-specific message. in some aspects, the information is transmitted via a group-common message. In some aspects, the uplink control channel is a PUCCH. In some aspects, transmitting the information includes transmitting the information aperiodically. In some aspects, the information explicitly indicates a number of times associated with repeating the communication. In some aspects, the information implicitly indicates a number of times associated with repeating the communication.

As further shown in FIG. 6, in some aspects, process 600 may include receiving the communication associated with the uplink control channel based at least in part on the information (block 620). For example, the transmitter (e.g., using reception component 802, depicted in FIG. 8) may receive the communication associated with the uplink control channel based at least in part on the information, as described above in connection with FIGS. 3 and 4.

In some aspects, the uplink control channel is a PUCCH, and receiving the communication includes receiving a short PUCCH. In some aspects, receiving the communication includes receiving uplink control information. In some aspects, receiving the communication includes receiving the communication over multiple slots. In some aspects, receiving the communication includes receiving the communication utilizing successive slots.

Process 600 may include additional aspects, such as any single aspect or any combination of aspects described above, below, and/or in connection with one or more other processes described elsewhere herein.

In a first aspect, process 600 includes the uplink control channel is a PUCCH, and receiving the communication includes receiving a short PUCCH.

In a second aspect, alone or in combination with the first aspect, receiving the communication includes receiving uplink control information.

In a third aspect, alone or in combination with one or more of the first and second aspects, the information indicates performance of a sweep of a reception beam associated with the communication.

In a fourth aspect, alone or in combination with one or more of the first through third aspects, the information indicates that the transmitter is to perform a sweep of a reception beam associated with the communication.

In a fifth aspect, alone or in combination with one or more of the first through fourth aspects, the information indicates performance of a sweep of a transmission beam associated with the communication.

In a sixth aspect, alone or in combination with one or more of the first through fifth aspects, the information indicates that the UE is to perform a sweep of a transmission beam associated with the communication.

In a seventh aspect, alone or in combination with one or more of the first through sixth aspects, process 600 includes the communication includes uplink control information, and the information indicates a number of times associated with repeating the communication.

In an eighth aspect, alone or in combination with one or more of the first through seventh aspects, the information is transmitted via a network configuration message.

In a ninth aspect, alone or in combination with one or more of the first through eighth aspects, the information is transmitted via a DCI message or via a MAC message.

In a tenth aspect, alone or in combination with one or more of the first through ninth aspects, the information is transmitted via a UE-specific message.

In an eleventh aspect, alone or in combination with one or more of the first through tenth aspects, the information is transmitted via a group-common message.

In a twelfth aspect, alone or in combination with one or more of the first through eleventh aspects, the uplink control channel is a PUCCH.

In a thirteenth aspect, alone or in combination with one or more of the first through twelfth aspects, transmitting the information includes transmitting the information aperiodically.

In a fourteenth aspect, alone or in combination with one or more of the first through thirteenth aspects, receiving the communication includes receiving the communication over multiple slots.

In a fifteenth aspect, alone or in combination with one or more of the first through fourteenth aspects, receiving the communication includes receiving the communication utilizing successive slots.

In a sixteenth aspect, alone or in combination with one or more of the first through fifteenth aspects, the information explicitly indicates a number of times associated with repeating the communication.

In a seventeenth aspect, alone or in combination with one or more of the first through sixteenth aspects, the information implicitly indicates a number of times associated with repeating the communication.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example apparatus 700 associated with dynamic repetition for a control channel, in accordance with the present disclosure. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include one or more of a determination component 708, among other examples.

In some aspects, the apparatus 700 may be configured to perform one or more operations described herein in connection with FIGS. 3 and 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be collocated with the reception component 702 in a transceiver.

The reception component 702 may receive, from a transmitter, information regarding repeating a communication associated with an uplink control channel. The transmission component 704 may transmit the communication associated with the uplink control channel based at least in part on the information.

The determination component 708 may determine, among other things, whether the information indicates a performance of a sweep of a reception beam and/or a transmission beam associated with the communication. In some aspects, the determination component 708 may include, for example, one or more antennas, a modulator, a transmit MIMO processor, a transmit processor, a controller/processor, a memory, or a combination thereof, of the UE described above in connection with FIG. 2.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram illustrating an example apparatus 800 associated with dynamic repetition for a control channel, in accordance with the present disclosure. The apparatus 800 may be a transmitter (e.g., base station), or a transmitter may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include one or more of a determination component 808, among other examples.

In some aspects, the apparatus 800 may be configured to perform one or more operations described herein in connection with FIGS. 3 and 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the transmitter described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a demodulator, a MIMO detector, a receive processor, a controller/processor, a memory, or a combination thereof, of the transmitter described above in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the transmitter described above in connection with FIG. 2. In some aspects, the transmission component 804 may be collocated with the reception component 802 in a transceiver.

The transmission component 804 may transmit, to a UE, information regarding repeating a communication associated with an uplink control channel. The reception component 802 may receive the communication associated with the uplink control channel based at least in part on the information.

The determination component 808 may determine, among other things, provision of data associated with indicating, in the information, a performance of a sweep of a reception beam and/or a transmission beam associated with the communication. In some aspects, the determination component 808 may include, for example, one or more antennas, a modulator, a transmit MIMO processor, a transmit processor, a controller/processor, a memory, or a combination thereof, of the transmitter (e.g., base station) described above in connection with FIG. 2.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving, from a transmitter, information regarding repetition of a communication associated with an uplink control channel; and transmitting the communication associated with the uplink control channel using repetition based at least in part on the information.

Aspect 2: The method of Aspect 1, wherein the uplink control channel is a physical uplink control channel (PUCCH), and transmitting the communication includes transmitting a short PUCCH.

Aspect 3: The method of any of Aspects 1-2, wherein transmitting the communication includes transmitting uplink control information.

Aspect 4: The method of any of Aspects 1-3, wherein the information indicates performance of a sweep of a reception beam associated with the communication.

Aspect 5: The method of any of Aspects 1-4, wherein the information indicates that the transmitter is to perform a sweep of a reception beam associated with the communication.

Aspect 6: The method of any of Aspects 1-5, wherein the information indicates performance of a sweep of a transmission beam associated with the communication.

Aspect 7: The method of any of Aspects 1-6, wherein the information indicates that the UE is to perform a sweep of a transmission beam associated with the communication.

Aspect 8: The method of any of Aspects 1-7, wherein the communication includes uplink control information, and the information indicates a number of times associated with repeating the communication.

Aspect 9: The method of any of Aspects 1-8, wherein the information is received via a configuration message.

Aspect 10: The method of any of Aspects 1-9, wherein the information is received via a downlink control information (DCI) message or via a medium access control (MAC) message.

Aspect 11: The method of any of Aspects 1-10, wherein the information is received via a UE-specific message.

Aspect 12: The method of any of Aspects 1-11, wherein the information is received via a group-common message.

Aspect 13: The method of any of Aspects 1-12, wherein the uplink control channel is a physical uplink control channel (PUCCH).

Aspect 14: The method of any of Aspects 1-13, wherein receiving the information includes receiving the information aperiodically.

Aspect 15: The method of any of Aspects 1-14, wherein transmitting the communication includes transmitting the communication over multiple slots.

Aspect 16: The method of any of Aspects 1-15, wherein transmitting the communication includes transmitting the communication in successive slots.

Aspect 17: The method of any of Aspects 1-16, wherein the information explicitly indicates a number of times associated with repeating the communication.

Aspect 18: The method of any of Aspects 1-16, wherein the information implicitly indicates a number of times associated with repeating the communication.

Aspect 19: A method of wireless communication performed by a transmitter, comprising: transmitting, to a user equipment (UE), information regarding repetition of a communication associated with an uplink control channel; and receiving the communication associated with the uplink control channel using repetition based at least in part on the information.

Aspect 20: The method of Aspect 19, wherein the uplink control channel is a physical uplink control channel (PUCCH), and receiving the communication includes receiving a short PUCCH.

Aspect 21: The method of any of Aspects 19-20, wherein receiving the communication includes receiving uplink control information.

Aspect 22: The method of any of Aspects 19-21, wherein the information indicates performance of a sweep of a reception beam associated with the communication.

Aspect 23: The method of any of Aspects 19-22, wherein the information indicates that the transmitter is to perform a sweep of a reception beam associated with the communication.

Aspect 24: The method of any of Aspects 19-23, wherein the information indicates performance of a sweep of a transmission beam associated with the communication.

Aspect 25: The method of any of Aspects 19-24, wherein the information indicates that the UE is to perform a sweep of a transmission beam associated with the communication.

Aspect 26: The method of any of Aspects 19-25, wherein the communication includes uplink control information, and the information indicates a number of times associated with repeating the communication.

Aspect 27: The method of any of Aspects 19-26, wherein the information is transmitted via a network configuration message.

Aspect 28: The method of any of Aspects 19-27, wherein the information is transmitted via a downlink control information (DCI) message or via a medium access control (MAC) message.

Aspect 29: The method of any of Aspects 19-28, wherein the information is transmitted via a UE-specific message.

Aspect 30: The method of any of Aspects 19-29, wherein the information is transmitted via a group-common message.

Aspect 31: The method of any of Aspects 19-30, wherein the uplink control channel is a physical uplink control channel (PUCCH).

Aspect 32: The method of any of Aspects 19-31, wherein transmitting the information includes transmitting the information aperiodically.

Aspect 33: The method of any of Aspects 19-32, wherein receiving the communication includes receiving the communication over multiple slots.

Aspect 34: The method of any of Aspects 19-33, wherein receiving the communication includes receiving the communication utilizing successive slots.

Aspect 35: The method of any of Aspects 19-34, wherein the information explicitly indicates a number of times associated with repeating the communication.

Aspect 36: The method of any of Aspects 19-35, wherein the information implicitly indicates a number of times associated with repeating the communication.

Aspect 37: An apparatus for wireless communication at a device, comprising a processor; memory coupled with the processor; and instructions stored in the memory and executable by the processor to cause the apparatus to perform the method of one or more of Aspects 1-36.

Aspect 38: A device for wireless communication, comprising a memory and one or more processors coupled to the memory, the one or more processors configured to perform the method of one or more of Aspects 1-36.

Aspect 39: An apparatus for wireless communication, comprising at least one means for performing the method of one or more of Aspects 1-36.

Aspect 40: A non-transitory computer-readable medium storing code for wireless communication, the code comprising instructions executable by a processor to perform the method of one or more of Aspects 1-36.

Aspect 41: A non-transitory computer-readable medium storing a set of instructions for wireless communication, the set of instructions comprising one or more instructions that, when executed by one or more processors of a device, cause the device to perform the method of one or more of Aspects 1-36.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a transmitter, information regarding repetition of a communication associated with an uplink control channel; and
transmit the communication associated with the uplink control channel using repetition based at least in part on the information.

2. The UE of claim 1, wherein the uplink control channel is a short physical uplink control channel (PUCCH).

3. The UE of claim 1, wherein the information indicates that the transmitter is to perform a sweep of a reception beam associated with the communication.

4. The UE of claim 1, wherein the information indicates that the UE is to perform a sweep of a transmission beam associated with the communication.

5. The UE of claim 1, wherein
the communication includes uplink control information, and
the information indicates a number of times associated with repetition of the communication.

6. The UE of claim 1, wherein the information is received via a configuration message.

7. The UE of claim 1, wherein the information is received via a downlink control information (DCI) message or via a medium access control (MAC) message.

8. The UE of claim 1, wherein the information is received via a UE-specific message.

9. The UE of claim 1, wherein the information is received via a group-common message.

10. The UE of claim 1, wherein the one or more processors, to receive the information, are configured to receive the information aperiodically.

11. The UE of claim 1, wherein the one or more processors, to transmit the communication, are configured to transmit the communication over multiple slots.

12. The UE of claim 1, wherein the one or more processors, to transmit the communication, are configured to transmit the communication in successive slots.

13. The UE of claim 1, wherein the information explicitly indicates a number of times associated with repeating the communication.

14. The UE of claim 1, wherein the information implicitly indicates a number of times associated with repeating the communication.

15. A transmitter for wireless communication, comprising:
a memory; and
one or more processors, coupled to the memory, configured to:
transmit, to a user equipment (UE), information regarding repetition of a communication associated with an uplink control channel; and
receive the communication associated with the uplink control channel using repetition based at least in part on the information.

16. The transmitter of claim 15, wherein the uplink control channel is a short physical uplink control channel (PUCCH).

17. The transmitter of claim 15, wherein the information indicates that the transmitter is to perform a sweep of a reception beam associated with the communication.

18. The transmitter of claim 15, wherein the information indicates that the UE is to perform a sweep of a transmission beam associated with the communication.

19. The transmitter of claim 15, wherein the communication includes uplink control information, and the information indicates a number of times associated with repetition of the communication.

20. The transmitter of claim 15, wherein the information is transmitted via a configuration message.

21. The transmitter of claim 15, wherein the information is transmitted via a downlink control information (DCI) message or via a medium access control (MAC) message.

22. The transmitter of claim 15, wherein the uplink control channel is a physical uplink control channel (PUCCH).

23. The transmitter of claim 15, wherein the one or more processors, to receive the communication, are configured to receive the communication in multiple slots.

24. The transmitter of claim 15, wherein the one or more processors, to receive the communication, are configured to receive the communication in successive slots.

25. The transmitter of claim 15, wherein the information explicitly indicates a number of times associated with repeating the communication.

26. The transmitter of claim 15, wherein the information implicitly indicates a number of times associated with repeating the communication.

27. A method of wireless communication performed by a user equipment (UE), comprising:
receiving, from a transmitter, information regarding repetition of a communication associated with an uplink control channel; and
transmitting the communication associated with the uplink control channel using repetition based at least in part on the information.

28. The method of claim 27, wherein the uplink control channel is a short physical uplink control channel (PUCCH).

29. A method of wireless communication performed by a transmitter, comprising:
transmitting, to a user equipment (UE), information regarding repetition of a communication associated with an uplink control channel; and
receiving the communication associated with the uplink control channel using repetition based at least in part on the information.

30. The method of claim 29, wherein the uplink control channel is a short physical uplink control channel (PUCCH).
